(19) United States
(12) Patent Application Publication
(10) Pub. No.: US 2002/0110167 A1
(43) Pub. Date: Aug. 15, 2002

(54) Modulators for vertical cavity surface emitting lasers

(76) Inventor: Raymond B. Patterson III, Melbourne, FL (US)

Correspondence Address: CHRISTIE, PARKER & HALE, LLP, P.O. BOX 7068, PASADENA, CA, 91109-7068, US

(21) Appl. No.: 10/121,332

(22) Filed: Apr. 12, 2002

Related U.S. Application Data
(63) Continuation of application No. 10/012,787, filed on Nov. 6, 2001.
(60) Provisional application No. 60/246,301, filed on Nov. 6, 2000.

(51) Int. Cl. H01S 3/10; H01S 3/00

(52) U.S. Cl. 372/38.02; 372/26

(57) ABSTRACT

A drive circuitry that drives a number of vertical cavity surface emitting lasers having a common cathode. The drive circuitry includes a modulator and a dummy laser. The modulator controls the vertical cavity surface emitting lasers. A modulation and bias current is directed to one of the vertical cavity surface emitting lasers to turn on the laser. A modulation current is directed away from the vertical cavity surface emitting laser to turn off the laser.

CROSS-REFERENCE TO THE RELATED APPLICATIONS

This application is a continuing application of U.S. patent application Ser. No. 10/012,787 which claims the benefit of U.S. provisional application No. 60/246,301 filed Nov. 6, 2000 which are hereby incorporated by reference as if set forth in full herein.

### BACKGROUND

The present invention relates generally to semiconductor lasers, and, more particularly, to methods and circuits for modulating data communication lasers.

Semiconductor lasers are widely used in high speed data communications. Modulated light from the lasers are used to carry information through fiber optic lines. For some data formats, generally, when a laser emits light the data value is considered a logical one and when the laser is largely off the data value is considered a zero.

Vertical cavity surface emitting lasers (VCSELs) are one type of laser used in data communication networks. VCSELs are generally relatively easy to manufacture using semiconductor processes and light from VCSELs is emitted from the VCSELs' surfaces, rather than from their edges. Hence, VCSELs are able to be manufactured on a common substrate and thus a common cathode. Conversely, other lasers in which light is emitted from their edges or sides, only a single laser or a comparatively small number of lasers are able to be constructed on a common substrate.

Typically, drive circuitry for VCSELs provide a VCSEL with sufficient current to turn “on”, i.e., cause the VCSEL to emit light. Likewise, the drive circuitry removes or prevents current from flowing to the VCSEL to turn the VCSEL “off”, i.e., cause the VCSEL to not emit light or, more generally, emit light at a reduced intensity. In high speed data communications, for directly modulated VCSELs, the drive circuitry should be able to drive the individual anodes of the individual VCSELs rapidly in order to switch the VCSEL on and off at high rates of speed.

Operating with a five volts or less power supply and the limitations of typical transistors, driving the individual anodes of the individual VCSELs at high rates of speed is often difficult. Also, in order to maintain high data rates, the drive circuitry should supply a high speed current to the VCSELs to drive the VCSELs. However, wiring associated with the VCSEL and/or the drive circuitry introduces parasitic inductance and resistance. As a result, the high speed current through the associated wiring often generates noise to adjacent circuitry or distorts the current driving the VCSELs and/or the light emitted by the VCSELs.

### SUMMARY OF THE INVENTION

The present invention provides methods and circuits that control the modulation of a vertical cavity surface emitting laser. In one embodiment, a drive circuitry is provided that drives a plurality of semiconductor lasers with each laser having a cathode. Each cathode of the plurality of semiconductor lasers are common to a substrate. The drive circuitry includes a modulator and a dummy laser. The modulator is coupled to one of the plurality of semiconductor lasers and generates an output signal to control the one of the plurality of semiconductor lasers. The dummy laser is coupled to the modulator. The modulator also includes a steering circuit that directs current to one of the dummy laser and the one of the plurality of semiconductor lasers.

In another embodiment, the drive circuitry is provided that drives a plurality of semiconductor lasers with each laser having a cathode. Each cathode of the plurality of semiconductor lasers are common to a substrate. The drive circuitry includes a modulator coupled to one of the plurality of semiconductor lasers and controls the one of the plurality of semiconductor lasers. A dummy laser is provided and is coupled to the modulator. The modulator also includes a steering circuit which directs current to one of the dummy laser and the one of the plurality of semiconductor lasers. The modulator also includes a first modulation and bias current source configured to generate a first modulation and bias current. The first modulation and bias current source is also coupled to the steering circuit and the dummy laser.

Many of the attendant features of this invention may be more readily appreciated as the same becomes better understood by reference to the following detailed description and considered in connection with the accompanying drawings.

### BRIEF DESCRIPTION OF THE DRAWINGS

FIG. 1 illustrates a block diagram of one embodiment of a modulator;

FIG. 2 illustrates a circuit diagram of one embodiment of the modulator of FIG. 1;

FIG. 3 illustrates a block diagram of another embodiment of a modulator; and

FIG. 4 illustrates a circuit diagram of one embodiment of the modulator of FIG. 3.

### DETAILED DESCRIPTION OF THE INVENTION

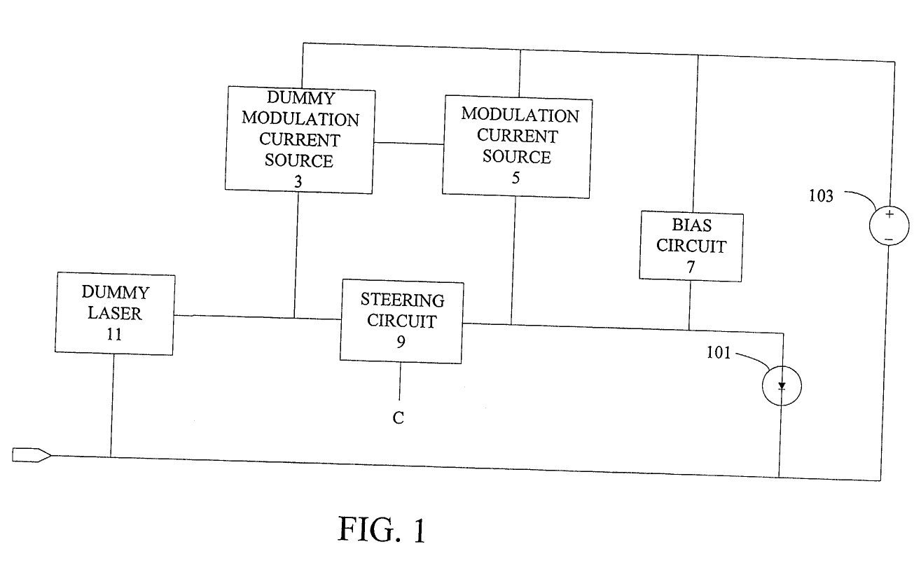

FIG. 1 illustrates a block diagram of one embodiment of a modulator driving a vertical cavity surface emitting laser. In FIG. 1, the modulator includes a modulation current source 5, a bias circuit 7, a steering circuit 9, and a laser 101. The bias circuit provides a bias current to the laser 5 so that the laser does not completely turn off. Such a bias current is useful in allowing the laser to more rapidly go from a decreased light emitting level to an increased light emitting level. The modulation current source provides the modulation current to the laser, depending on the state of the steering circuit. The state of the steering circuit is based on a control input C, which corresponds to data desired for transmission using the laser.

The modulator also includes a dummy modulation current source 3 and a dummy laser. The dummy modulation current source is coupled to a power supply 103, the steering circuit 9 and the dummy laser 11. The dummy modulation current source is also coupled to the modulation current source 5. The dummy modulation current source mirrors the current output from the modulation current source and thus generates a similar modulation current, i.e., a dummy modulation current. The dummy modulation current is supplied to either the dummy laser 11 or the steering circuit 9.

The steering circuit connects a modulation current sink to the modulation current source or the dummy modulation current source, depending on the state of the control input. For example, in one embodiment, the steering circuit pulls current from the modulation current source when the control input indicates a logical one, with the current from the dummy modulation current source going through the dummy laser. Conversely, when the control input is a logical zero, current from the modulation current source is provided to the laser and current from the dummy modulation current source is passed through the steering circuit. With the dummy laser configured to largely match the impedance of the laser, the current generated by the power source is largely constant.

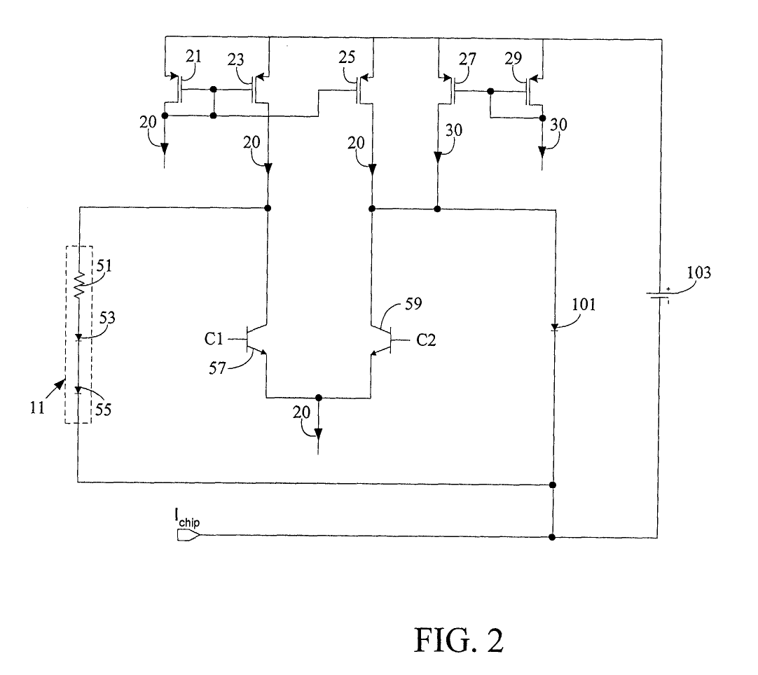

FIG. 2 illustrates a circuit diagram of one embodiment of a modulator and laser 101. The modulator includes 5 P-channel FETs 21, 23, 25, 27 and 29. The sources of FETs 21, 23, 25, 27 and 29 are coupled to a power supply 103. The power supply is also coupled to the VCSEL substrate. The FET 21 is driven by a modulation current 20 from a sink (not shown).

The gates of FETs 27 and 29 are coupled together and to the drain of FET 29. The drain of FET 27 is coupled to the laser 101. FETs 27 and 29 act as a current mirror and thus supply a bias current 30 to laser 101. FETs 21, 23, and 25 are gate coupled, with the gates coupled to the drain of FET 21. FETs 21, 23 and 25 act as a current mirror. As such, a modulation current 20 is provided to a dummy laser 11 or a bipolar junction transistor (BJT) 57, both coupled to FET 23 via its drain. Likewise, a modulation current is provided to laser 101 or BJT 59, both coupled to FET 25 via its drain. The dummy laser 11 includes resistor 51 and diodes 53 and 55.

Control voltage or inputs C1 and C2 are provided between the bases of BJTs 57 and 59 of such a magnitude as to completely switch the modulation current 20 through BJT 57 or BJT 59. Accordingly, current from FET 25 flows to the laser when Cl is more positive then C2 or through transistor BJT 59 when C2 is more positive then C1. Similarly, current from FET 23 flows to the dummy laser when C2 is more positive then C1 or through BJT 57 when C1 is more positive then C2.

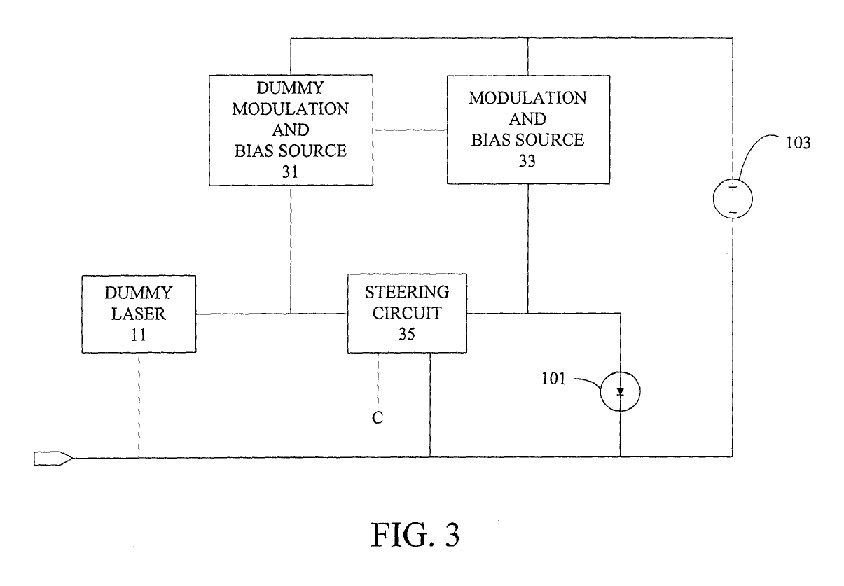

FIG. 3 illustrates a block diagram of another embodiment of a modulator for driving vertical cavity surface emitting lasers of the present invention. In FIG. 1, the modulator includes a dummy modulation and bias current source 31, a modulation and a bias current source 33, a steering circuit 35 and a dummy laser 11. The dummy modulation and bias current source 31 is coupled to the steering circuit 35 and the dummy laser 11. The dummy modulation and bias current source 31 is also coupled to the modulation and bias current source 33. The modulation and bias current source is coupled to steering circuit 35 and a vertical cavity surface emitting laser 101. The modulation and bias current source and the dummy modulation and bias current source are coupled to one terminal of a power supply 103. The other terminal of power supply 103 is coupled to the substrate of the laser 101 and to the dummy laser 11.

The dummy modulation and bias current source 31 provides a dummy summed modulation and bias current. Steering circuit 35 allows the dummy summed modulation and bias current to flow into dummy laser 11 or removes the modulation current to leave only the bias current. The modulation and bias current source 33 coupled to the dummy modulation and bias current source 31 also provides a summed modulation and bias current that mirrors the dummy summed modulation and bias current. Likewise, the steering circuit 35 allows the summed modulation and bias current to flow into the laser 101 or removes the modulation current to leave only the bias current. The steering circuit 35 also receives a control input C that directs the dummy summed modulation and bias current towards the dummy laser 11 or directs the summed modulation and bias current towards the laser 101.

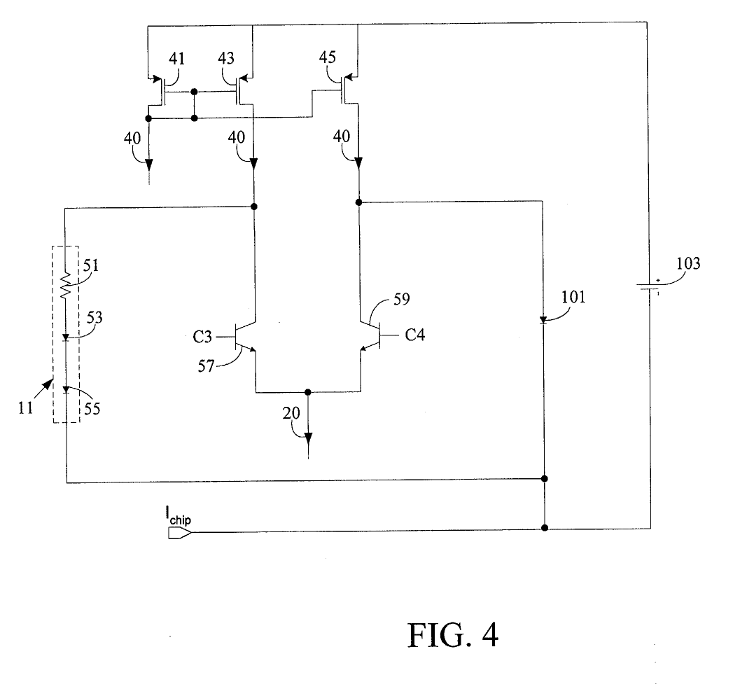

FIG. 4 illustrates a circuit diagram of one embodiment of the modulator of FIG. 3. The modulator includes 3 P-channel FETs 41, 43 and 45. The sources of FETs 41, 43 and 45 are coupled to a power supply 103. The power supply, in one embodiment, is 5 volts or less. The power supply is coupled to the laser 101 and the dummy laser 11. Gates of FETs 41 and 43 are coupled together and the drain of FET 41. As such, FETs 41 and 43 act as a current mirror which provides a summed modulation and bias current 40 to dummy laser 11 or a modulation current 20 to BJT 57 and a bias current only to dummy laser 11. The gates of FETs 41 and 43 are also coupled to the gate of FET 45. FETs 41 and 45 act as a current mirror to provide a summed modulation and bias current to laser 101 or a modulation current to BJT 59 and a bias current only to laser 101. The dummy laser 11 includes a resistor 51 which is coupled to diode 53. The cathode of diode 53 is coupled to the anode of diode 55. The cathode of diode 55 is coupled to laser 101 and power supply 103.

Control voltage or inputs C3 and C4 are provided between the bases of BJT 57 and BJT 59 of such a magnitude as to completely switch the modulation current 20 through BJT 57 or BJT 59. Accordingly, the summed modulation and bias current from FET 45 flows to laser 101 when C3 is more positive then C4 or only the bias current flows to the laser 101 while the modulation current is diverted through BJT 59 when C4 is more positive then C3. Similarly, the summed modulation and bias current from FET 43 flows to the dummy laser when C4 is more positive then C3 or only the bias current flows to the dummy laser while the modulation current is diverted through BJT 57 when C3 is more positive then C4. As such, a modulation and bias current is supplied to laser 101 or to dummy laser 11, but not to both the dummy laser 11 and laser 101 at the same time. Thus, the modulation currents through and from the power supply 103 remains constant. As such, parasitic inductance and resistance associated with wiring from the power supply to the other components, e.g., to modulation and bias current source 33 (FIG. 3), and any mutual inductance and capacitance to other wiring does not cause the modulation and bias current to produce voltage noise in adjacent circuitry or distort the signal current required by laser 101 to output light.

Accordingly, the present invention provides methods and systems that control the modulation of vertical cavity surface emitting lasers. Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims, their equivalents and claims supported by this specification.

What is claimed is:

1. A drive circuitry driving a plurality of semiconductor lasers each having a cathode, each cathode of the plurality of semiconductor lasers being common to a substrate, the drive circuitry comprising:
a modulator coupled to one of the plurality of semiconductor lasers and controls the one of the plurality of semiconductor lasers; and
a dummy laser coupled to the modulator;
wherein the modulator comprises a steering circuit causing a modulation current to flow to one of the dummy laser and the one of the plurality of semiconductor lasers.

2. The drive circuitry of claim 1 wherein the modulator comprises a first modulation current source configured to generate a first modulation current and coupled to the steering circuit and the dummy laser.

3. The drive circuitry of claim 2 wherein the steering circuit causes the first modulation current to flow to the dummy laser.

4. The drive circuitry of claim 3 wherein the steering circuit causes the first modulation current to be diverted away from the dummy laser.

5. The drive circuitry of claim 4 wherein the modulator comprises a second modulation current source configured to generate a second modulation current and coupled to the steering circuit and one of the plurality of semiconductor lasers.

6. The drive circuitry of claim 5 wherein the steering circuit causes the second modulation current to flow to one of the plurality of semiconductor lasers.

7. The drive circuitry of claim 6 wherein the steering circuit causes the second modulation current to be diverted away from the one of the plurality of semiconductor lasers.

8. The drive circuitry of claim 1 wherein the modulator comprises a bias circuit configured to generate a bias current and coupled to the steering circuit and one of the plurality of semiconductor lasers.

9. The drive circuitry of claim 5 wherein the first modulation current source comprises at least one transistor acting as a current mirror.

10. The drive circuitry of claim 2 wherein the second modulation current source comprises at least one transistor acting as a current mirror.

11. The drive circuitry of claim 1 wherein the steering circuit comprises of a plurality of transistors and receives two control inputs.

12. The drive circuitry of claim 5 wherein the steering circuit comprises a plurality of transistors and receives two control inputs.

13. The drive circuitry of claim 11 wherein the steering circuit causes the first modulation current to flow to the dummy laser based on the two control inputs received.

14. The drive circuitry of claim 12 wherein the steering circuit causes the second modulation current to flow to the one of the plurality of semiconductor lasers based on the two control inputs received.

15. The drive circuitry of claim 11 wherein the steering circuit causes the first modulation current to be diverted away from the dummy laser based on a first one of the two control inputs being more positive then a second one of the two control inputs.

16. The drive circuitry of claim 12 wherein the steering circuit causes the second modulation current to be diverted away from the one of the plurality of semiconductor lasers based on a second one of the two control inputs being more positive then a first one of the two control inputs.

17. The drive circuitry of claim 1 wherein the plurality of semiconductor lasers are vertical cavity surface emitting lasers.

18. A drive circuitry driving a plurality of semiconductor lasers each having a cathode, each cathode of the plurality of semiconductor lasers being common to a substrate, the drive circuitry comprising:
a modulator coupled to one of the plurality of semiconductor lasers and controlling the one of the plurality of semiconductor lasers; and
a dummy laser coupled to the modulator;
wherein the modulator comprises a steering circuit directing current to one of the dummy laser and the one of the plurality of semiconductor lasers and a first modulation and bias current source configured to generate a first summed modulation and bias current and coupled to the steering circuit and the dummy laser.

19. The drive circuitry of claim 18 wherein the steering circuit directs the first summed modulation and bias current to the dummy laser.

20. The drive circuitry of claim 19 wherein the steering circuit removes a modulation current from the first summed modulation and bias current.

21. The drive circuitry of claim 18 wherein the modulator comprises a second modulation and bias current source configured to generate a second summed modulation and bias current and coupled to the steering circuit and the one of the plurality of semiconductor lasers.

22. The drive circuitry of claim 21 wherein the steering circuit directs the second summed modulation and bias current to the one of the plurality of semiconductor lasers.

23. The drive circuitry of claim 22 wherein the steering circuit removes a modulation current from the second summed modulation and bias current.

24. The drive circuitry of claim 19 wherein the first modulation and bias current source comprises at least one transistor acting as a current mirror.

25. The drive circuitry of claim 21 wherein the second modulation and bias current source comprises at least one transistor acting as a current mirror.

26. The drive circuitry of claim 19 wherein the steering circuit comprises of a plurality of transistors and receives two control inputs.

27. The drive circuitry of claim 26 wherein the steering circuit directs a modulation current from the first summed modulation and bias current to one of the plurality of transistors and a bias current from the first summed modulation and bias current to the dummy laser based on the two control inputs received.

28. The drive circuitry of claim 27 further comprising a first one of the two control inputs received being more positive then a second one of the two control inputs.

29. The drive circuitry of claim 21 wherein the steering circuit comprises a plurality of transistors and receives two control inputs.

30. The drive circuitry of claim 29 wherein the steering directs a modulation current from the second summed modulation and bias current to one of the plurality of transistors and a bias current from the second summed modulation and bias current to the one of the plurality of semiconductor lasers based on the two control inputs received.

31. The drive circuitry of claim 30 further comprising a second one of the two control inputs received being more positive then a first one of the two control inputs.

32. The drive circuitry of claim 28 wherein the plurality of semiconductor lasers are vertical cavity surface emitting lasers.

33. A drive circuitry comprising:
means for imitating a characteristic of a semiconductor laser;
means for steering a first summed modulation and bias current source to one of a plurality of semiconductor lasers; and
means for steering a dummy summed modulation and bias current to the means for imitating a characteristic of a semiconductor laser.
